(19) United States
(12) Patent Application Publication
(10) Pub. No.: US 2015/0204684 A1
(43) Pub. Date: Jul. 23, 2015

(54) METHODS AND SYSTEMS OF MULTI-DIMENSIONAL AUTOMATED RIDE-SHARING OPTIMIZATION

(71) Applicants: Abtin ROSTAMIAN, san francisco, CA (US); jimmy KU, EMERYVILLE, CA (US)

(72) Inventors: Abtin ROSTAMIAN, san francisco, CA (US); jimmy KU, EMERYVILLE, CA (US)

(21) Appl. No.: 14/601,219

(22) Filed: Jan. 20, 2015

Related U.S. Application Data
(60) Provisional application No. 61/929,498, filed on Jan. 21, 2014.
(60) Provisional application No. 61/975,795, filed on Apr. 5, 2014.
(60) Provisional application No. 62/027,392, filed on Jul. 22, 2014.

(51) Int. Cl. G01C 21/34

(52) U.S. Cl. CPC G01C 21/3438

(57) ABSTRACT

In one embodiment, a method includes the step of automatically determining a loop route for an automated ride-sharing service. The loop route comprises a dynamic traveling route with one or more pickup/drop off points. A request is received from a rider to ride in a ride-sharing vehicle in the loop route. A driver profile is generated for a driver of the ride-share vehicle. A co-rider profile is generated for a co-rider in the ride-share vehicle. A ride-share vehicle restriction is received. A vehicle ride profile is generated based on the driver profile, the co-rider profile and the ride-share vehicle restriction. A rider profile is generated for the rider. The rider profile is matched with the vehicle ride profile. A pickup is scheduled for the rider by the ride-share vehicle. A drop off is scheduled for the rider by the ride-share vehicle.

### CROSS-REFERENCE TO RELATED APPLICATIONS

This application claims priority to U.S. provisional patent application No. 61/929,498, titled METHODS AND SYSTEMS OF COMPUTER-IMPLEMENTED TRANSPORTATION, filed on 21 Jan. 2014. This application claims priority to U.S. provisional patent application No. 61/975,795, titled METHODS AND SYSTEMS OF COMPUTER-IMPLEMENTED TRANSPORTATION NETWORKING SERVICE, filed on 5 Apr. 2014. This application claims priority to U.S. provisional patent application No. 62,027,392, titled METHODS AND SYSTEMS OF MULTI-DIMENSIONAL AUTOMATED RIDE-SHARING OPTIMIZATION, filed on 22 Jul. 2014. These applications are incorporated herein by reference.

### BACKGROUND

1. Field

This application relates generally to ride sharing, and more specifically to a system, article of manufacture and method of methods and systems of multi-dimensional automated ride-sharing optimization.

2. Related Art

Various car service businesses have maintained static business and transportation methods for a long period of time. For example, bus services offer static routes that are not dynamically updated based on various current conditions such as traffic, passenger pick up and/or drop off densities, etc. Bus routes are typically manually adjusted by a human route administrator. In another example, taxis and/or other ride services offer discreet rides to a single person or group. The group is left to coordinate its composition and drop off locations. In yet another example, current ride share services are often designed for transporting a pre-set group of people from one location to another. The ride services are not designed to automatically modify the composition of the group based on rider presences. Additionally, the ride services are not designed to automatically modify the route of the vehicle based on current rider preferences. Accordingly, improvements to current car and transportation service models can improve the rider's experience.

### BRIEF SUMMARY OF THE INVENTION

In one aspect, a method includes the step of automatically determining a loop route for an automated ride-sharing service. The loop route comprises a dynamic traveling route with one or more pickup/drop off points. A request is received from a rider to ride in a ride-sharing vehicle in the loop route. A driver profile is generated for a driver of the ride-share vehicle. A co-rider profile is generated for a co-rider in the ride-share vehicle. A ride-share vehicle restriction is received. A vehicle ride profile is generated based on the driver profile, the co-rider profile and the ride-share vehicle restriction. A rider profile is generated for the rider. The rider profile is matched with the vehicle ride profile. A pickup is scheduled for the rider by the ride-share vehicle. A drop off is scheduled for the rider by the ride-share vehicle.

### BRIEF DESCRIPTION OF THE DRAWINGS

FIG. 1 illustrates, in block diagram format, an example process for automatically generating a driver profile, according to some embodiments.

FIG. 2 illustrates an example process of generating a rider profile, according to some embodiments.

FIG. 3 illustrates an example process of generating a ride profile, according to some embodiments.

FIG. 4 illustrates a process for multidimensional automated ride-sharing optimization, according to some embodiments.

FIG. 5 illustrates a process of selecting a series of vehicles from multiple loops that a rider can use in sequence to reach a destination, according to some embodiments.

FIG. 6 depicts computing system with a number of components that may be used to perform any of the processes described herein.

FIG. 7 depicts, in block diagram format, a computerized system for implementing a multidimensional automated ride-sharing service, according to some embodiments.

The Figures described above are a representative set, and are not exhaustive with respect to embodying the invention.

### DETAILED DESCRIPTION

Disclosed are a system, method, and article of manufacture of multidimensional automated ride-sharing optimization. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” ‘one example,’ or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

As used herein in, use of terms such as ‘current’, ‘real time’ and/or other similar synonyms assume various latencies such as networking and/or processing latencies.

### DEFINITIONS

Collaborative filtering (e.g. memory based, model based, hybrid, etc.) can include a process of filtering for information or patterns using techniques involving collaboration among multiple agents, viewpoints, data sources, etc.

Gamification can be the use of game thinking and/or game mechanics in non-game contexts to engage users.

Machine learning can include the construction of systems that learn from data. Example machine learning techniques that can be used herein include, inter alia: decision tree learning, association rule learning, artificial neural networks, inductive logic programming, support vector machines, clustering, Bayesian networks, reinforcement learning, representation learning, similarity and metric learning, and/or sparse dictionary learning.

Mathematical optimization can be used to select the best element (with regard to some specified criteria) from some set of available alternatives.

Mobile device can include a handheld computing device that includes an operating system (OS), and can run various types of application software, known as ‘apps’ or applications. Example handheld devices can also be equipped with various context sensors (e.g. biosensors, physical environmental sensors, etc.), digital cameras, Wi-Fi, Bluetooth, and/or GPS capabilities. Mobile devices can allow connections to the Internet and/or other Bluetooth-capable devices, such as an automobile, a wearable computing system and/or a microphone headset. Exemplary mobile devices can include smart phones, tablet computers, optical head-mounted display (OHMD) (e.g. Google Glass®), virtual reality head-mounted display, smart watches, other wearable computing systems, etc.

Natural language processing (NLP) can include natural language understanding and other algorithms that enable computers to derive meaning from human and/or other natural language input. NLP can also provide for natural language generation (e.g. convert information from computer databases into readable human language).

Online social network service can serve as a platform to build social networks or social relations among people who, for example, share interests, activities, backgrounds and/or real-life connections. A social network service can consists of a representation of each user (e.g. a profile, an avatar, etc.), his/her social links, and a variety of additional services. Social networking can include web-based services that allow individuals to create a public profile, to create a list of users with whom to share connections, and to view connections within the system. In some embodiments, user social network profiles can be used to determine, not only advertisements, but other user experiences such as the music and/or radio stations selected for passengers based on their combined tastes.

Vehicle tracking system can include automatic vehicle location in individual vehicles. For example, a vehicle tracking system can use GPS and/or GLONASS (Global Navigation Satellite System) technology for locating the vehicle. A vehicle tracking system can be viewed on electronic maps. A vehicle tracking system can also be used to obtain other information about the vehicle such as repair needs, miles per gallon, etc. A vehicle tracking system can be used to determine if a driver is obeying local travel ordinances.

Weighting methods can include emphasizing the contribution of some aspects of a phenomenon (and/or of a set of data) to a final effect or result. Accordingly, some variables representing said phenomenon can be given more weight than other variables in an analysis.

Exemplary Systems and Methods

In one example embodiment, an automated ride-sharing service (and/or other transportation networking service, such as one that transports goods for delivery) can be implemented. As used herein, a ride-sharing service can include a service that arranges one-time shared rides (e.g. on short notice). This type of vehicle pooling can make use of various recent technological advances, such as, inter alia: GPS navigation devices to determine a driver's route and/or arrange the shared ride; smartphones for a traveler to request a ride from wherever they happen to be; social networks to establish trust and accountability between drivers and riders; etc. These elements can be coordinated through a computerized transportation network service (e.g. implemented in a server and/or in a cloud-computing environment). The computerized transportation network service can automatically and in real time (e.g. assuming networking and computer processing latencies and the like) handle such functionalities as: driver payments: matching rides; matching riders; etc. Various optimization algorithms can be utilized to implement the computerized network service (e.g. simplex algorithm of George Dantzig, designed for linear programming; extensions of the simplex algorithm, designed for quadratic programming and for linear-fractional programming; variants of the simplex algorithm that are especially suited for network optimization; various combinatorial algorithms; iterative methods such as methods that evaluate Hessians (and/or approximate Hessians), using finite differences such Newton's method and/or sequential quadratic programming; methods that evaluate gradients or approximate gradients using finite differences (or even sub-gradients) such as quasi-Newton methods, conjugate gradient methods, gradient descent, etc.; global convergence algorithms; heuristic algorithms, etc.).

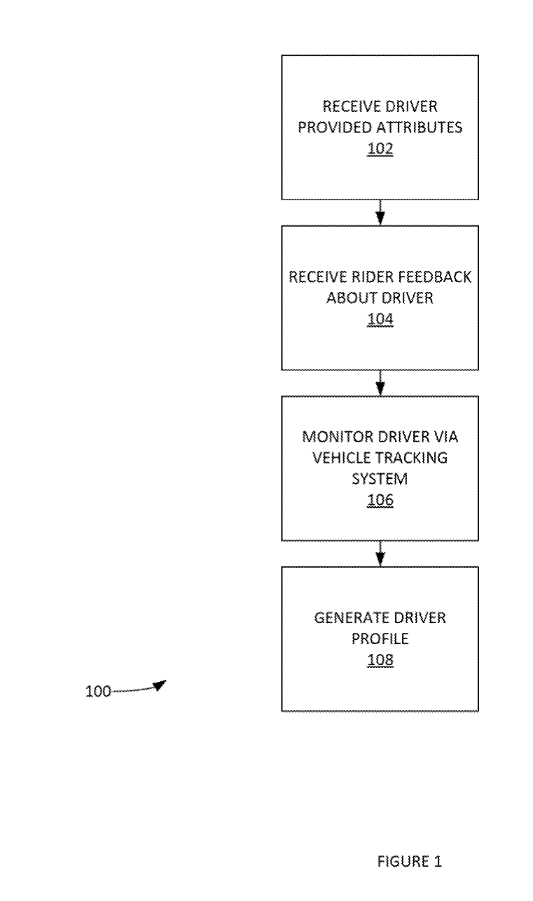

FIG. 1 illustrates, in block diagram format, an example process 100 for automatically generating a driver profile, according to some embodiments. In step 102 of process 100, a set of one or more driver provided attributes can be received. For example, a driver can indicate rider-attribute preferences, route preferences, driver profile information (e.g. including online social network profile information, etc.). For example, a driver can indicate a preference for non-talkative riders that prefer classical music and are not prioritizing vehicle speed. In another example rider can indicate a preference for other rider and/or driver attributes. For example, a rider can indicate that she does not want to ride with other talkative riders and/or drivers. In step 104, rider feedback about the driver can be received. For example, past riders can have previously rated the driver. These driver ratings can be stored in a driver profile database. In step 106, the driver's historical driving information can be monitored and obtained (e.g. via a vehicle monitoring system). In step 108, a driver profile can be generated and managed. The driver profile can include a set of driver preferences with respect to riders that may be matched with the driver.

It is noted at any step and/or permutation of steps of process 100 can be repeated in order to update said driver profile. Feedback from multiple riders can be obtained. It is noted that each step of process 100 can be expressed as a variable value with various added weights. The weights and/or other criteria can be based on various factors such as those determined by optimization algorithms (e.g. a stochastic optimization, combinatorial optimization, etc.), curated by a system administrator and/or other methods.

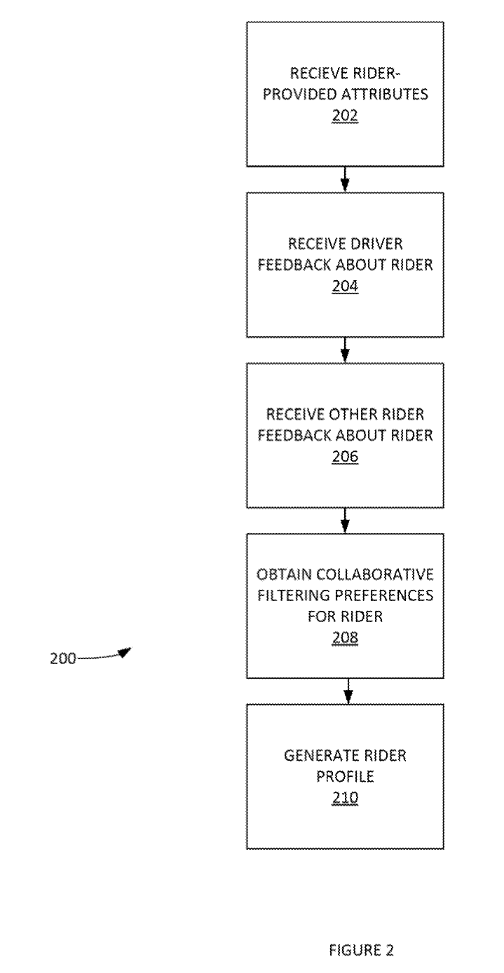

FIG. 2 illustrates an example process 200 of generating a rider profile, according to some embodiments. In step 202, rider-provided attributes can be received. For example, a rider can provide a set of preferences. Preferences can be generalized-system preferences (e.g. favorite music, preferred types of co-riders, preferred vehicle types, etc.) and/or ride-specific preferences that apply to the currently requested ride. Additionally, rider attributes can be obtained from rider profiles on other online social networks, and the like. In step 204, a history of past driver feedback about the rider can be received. For example, when a rider used the service, the driver can have the opportunity to rate the rider and/or provide other feedback (e.g. text-based feedback and the like). NLP algorithms can be used to interpret and derive the meaning of text-based feedback.

In step 206, other co-rider feedback about the rider can be obtained. For example, when a rider used the service, a co-rider (e.g. someone that shared a ride and/or portion of a ride with the rider) can be provided the opportunity to rate the rider and/or provide other feedback (e.g. text-based feedback and the like). In step 208, collaborative filtering recommendations can be obtained/determined for the rider as well. For example, various recommendation algorithms can be used predict rider preferences with respect to vehicles, drivers and/or other co-riders. In step 210, a rider profile can be generated. The rider profile can include a set of rider preferences with respect to vehicles, drivers and/or other co-riders that may be matched with the rider.

It is noted at any step and/or permutation of steps of process 200 can be repeated in order to update said driver profile. It is noted that each step of process 200 can be expressed as a variable value with various added weights. The weights and/or other criteria can be based on various factors such as those determined by optimization algorithms (e.g. a stochastic optimization, combinatorial optimization, etc.), curated by a system administrator and/or other methods.

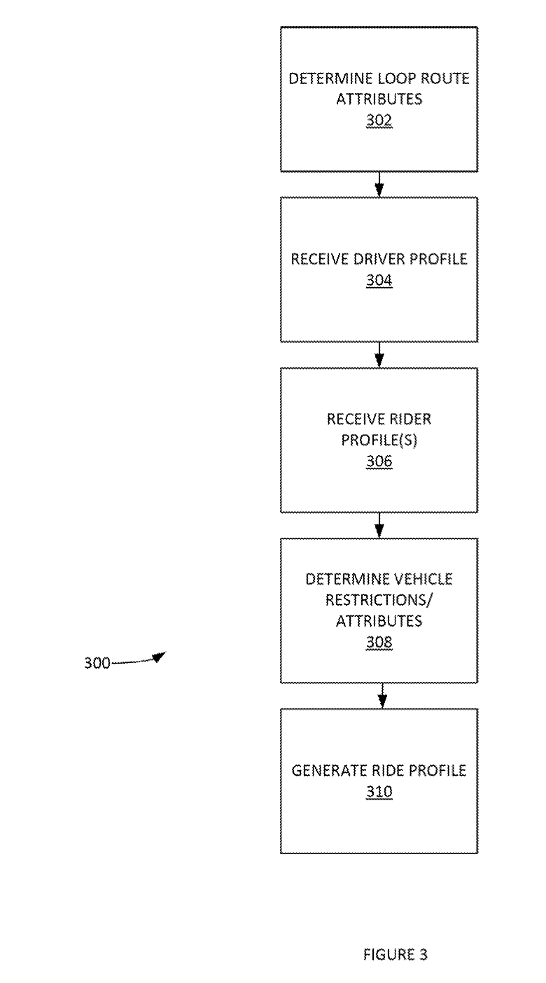

FIG. 3 illustrates an example process 300 of generating a ride profile, according to some embodiments. A ride profile can include a set of ride restrictions and/or other attributes associated with a specific period of a vehicle in a loop. For example, a vehicle may only be available to a specified set of users in a loop. For example, a set of riders can be verified as members of a specified profession (e.g. educators, information technology professionals, medical professionals, etc.) by a system curator or administrator. The ride profile can be set to only allow permission to verified members of a specified profession to ride in the vehicle. In another example, only riders that are verified by a specified rider can receive permission to access a ride in a specified vehicle. Accordingly, in step 302, a set of loop route attributes can be determined. Loop attributes of vehicles in the loop can include the destinations, transit neighborhood types, road types, etc. For example, a loop that traverses a financial district can be associated with the type of professionals that use the transportation service to access the financial district. In another example, a loop can traverse a district with a high density of information technology (IT) start-up enterprises. Accordingly, loop attributes of vehicles in the loop can be associated with start-up IT professionals (e.g. computer programmers, data-base administrators, etc.). In some embodiments, loops can include bidirectional vehicles. For example, some vehicles can travel in an opposite direction from other vehicles within the same loop. The system can automatically select an optimal direction for each rider within a loop. These loop attributes are provided by way of example and not of limitation.

Other specified types of co-riders can be based on attributes other than profession type. For example, a rider can set preferences for the gender, age, minor status, common interests, location of workplace, existing social connections with such as indirect acquaintances of a certain degree of separation in an online social network, common destination, common destination event (e.g. a concert, a play, a restaurant, an opera, etc.), commuters only, tourists and other non-commuters, attendees of a specified conference, wedding party attendees, amenities in the vehicle (e.g. a vehicle with Wi-Fi, hybrid vehicle, etc.), specified-language groups (can apply to driver, etc.), riders and/or drivers with a verified back-ground check with no criminal history, and the like. In another embodiment, the ride-share service can include a computer-implemented match-making service (e.g. an online dating service, a social-meeting application), etc. The match-making service can recommend co-riders and with attributes that a user has indicated as desirable for a romantic match. These attribute preferences can also be applied to vehicle drivers. Additionally, a rider can specify other preferences such as, inter alia, specify vehicle type, maximum number of other passengers, etc. A rider can specify whether a preference is mandatory or non-mandatory preference (e.g. ‘nice to have’).

In step 304, the driver profile of the vehicle providing the ride can be received. In step 306, the other rider profile(s) can be received. These can be the profiles of the other rider(s) that are assigned to be in the vehicle. Rider profiles can be filtered based on the required permissions (e.g. rider-type restrictions) for the ride (e.g. allow only verified start-up executives, allow only females, allow only persons under the age of twelve (12), etc.). In step 308, vehicle restrictions and/or other attributes can be determined (e.g. as provided supra). Accordingly, in step 310, a ride profile can be generated. Ride recommendation algorithms can be used to determine, inter alia, ride profiles, driver profiles, rider profiles, vehicle information, route information, destination information, and the like in order to recommend rides for riders.

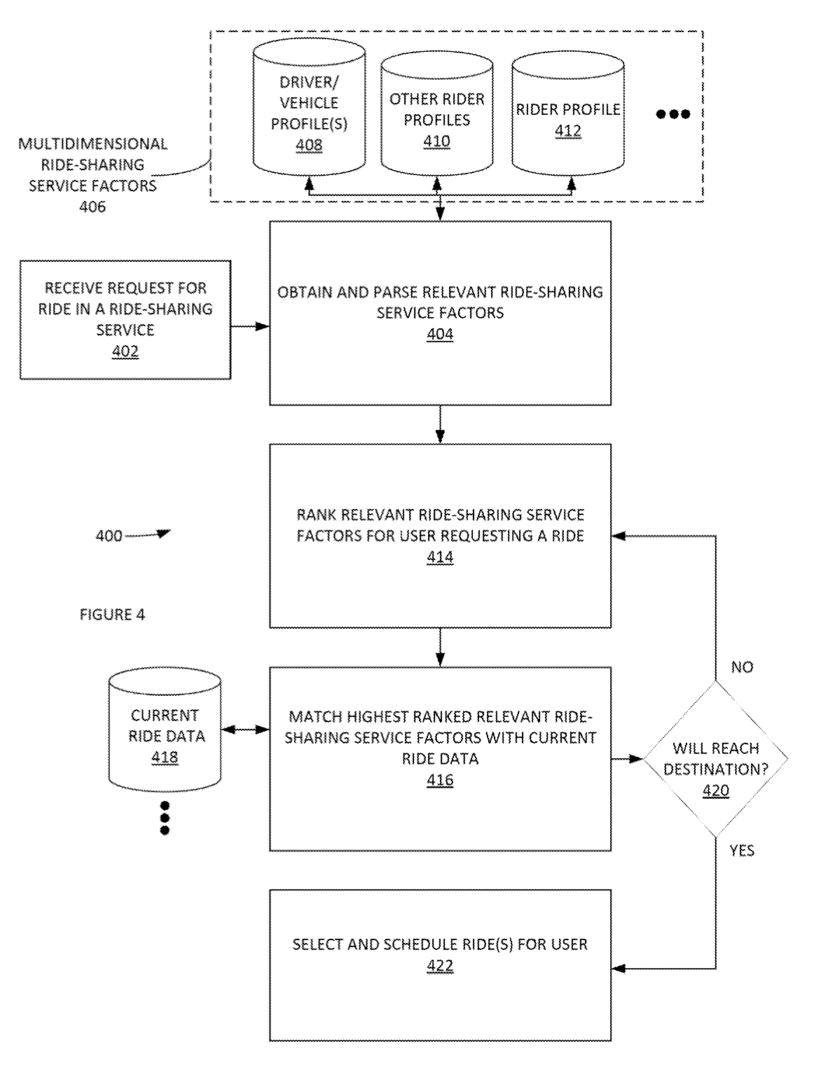

FIG. 4 illustrates a process 400 for multidimensional automated ride-sharing optimization, according to some embodiments. In step 402, a request for a ride in a ride-sharing service is received. In step 404, ride-sharing factors relevant to the request for the ride are obtained and parsed. Example relevant ride-sharing factors can be obtained from multidimensional ride-sharing factors database 406. Multidimensional ride-sharing factors database 406 can include such information as: driver/vehicle profiles 408, other rider profiles 410, rider profile 410 (e.g. the profile of the current user requesting the ride), etc. The relevant ride-sharing factors for the user and the requested ride can be ranked in step 414. In step 416, the highest ranked relevant ride-sharing factors can be matched with current ride data 418. Current ride data 418 can include currently available loops, loop schedules, proximity along the loop, distance, capacity, etc. In step 420, it can be determined if the current ride schedule is sufficient for the user to reach her destination. If additional rides in other loops are required, then process 400 can return to step 414. If no additional rides in other loops are required then process 400 can progress to step 422. In step 422, the various rides previously determined by process 400 can be selected and scheduled for the user.

In one example embodiment, the automated ride-sharing service can use information in multidimensional ride-sharing factors database 406 to select advertisements to present to riders during a ride. For example, it can be determined that a set of riders are using the service to travel to a night club. Rider profiles can indicate that they enjoy vodka. An advertisement for the night club's bottle service and an electronic coupon can be communicated to the riders (e.g. via text message, e-mail and/or digital messaging service). Additionally, in some examples, the social network profiles of riders can help to determine the music and/or radio stations selected for the passengers based on their combined tastes.

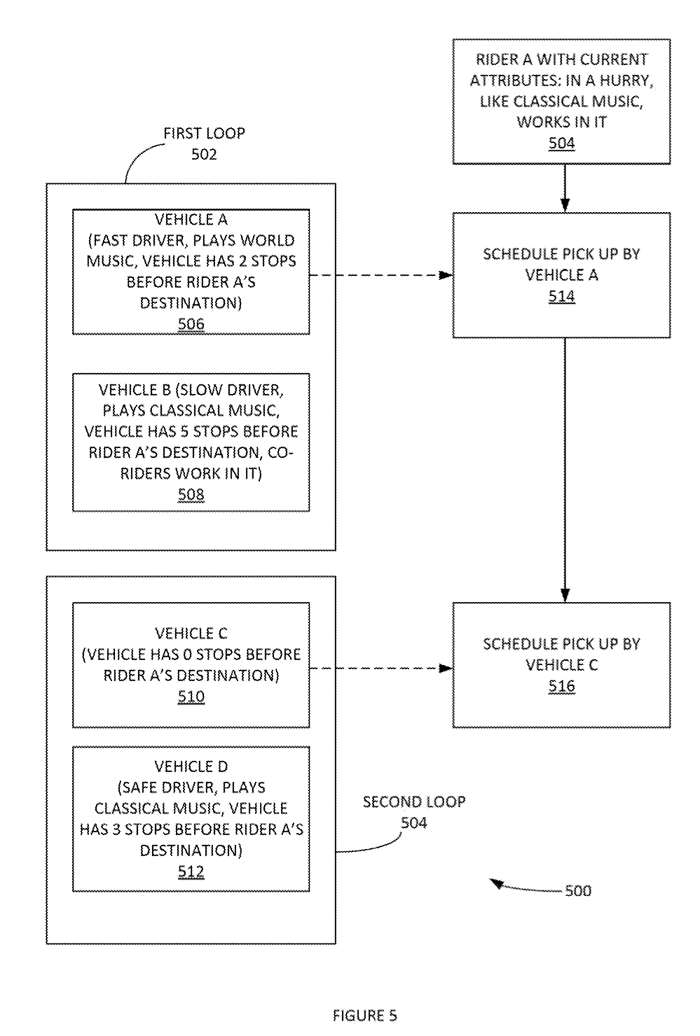

FIG. 5 illustrates a process 500 of selecting a series of vehicles from multiple loops to match with a rider according to some embodiments. The rider can be assigned the vehicles in sequential loops to reach her destination. In the example of process 500, a user (e.g. Rider A) may utilize two loops 502 and 504 to reach a destination. First loop 502 can include two vehicles: vehicle A 506 and vehicle B 508. Second loop 504 can include two vehicles: vehicle C 510 and vehicle D 512. Each vehicle can have attributes based on the vehicle profile, driver profile and/or other co-rider profile(s). In the present example of process 500, Rider A may indicate that she is currently ‘in a hurry’. Rider A's profile can include additional information as shown (e.g. works in information technology (IT)). The system can provide various weights to Rider A's attributes. Accordingly, the ‘in a hurry’ attribute can receive greater weight than other profile attributes. Accordingly, Rider A's weighted profile can be used to match Rider A with various vehicle ride opportunities in the two loops. For example, vehicle A's profile can indicate that it will complete the route with first loop 502 before vehicle B 508. Accordingly, vehicle A 506 can be selected and a ride scheduled for Rider A. Additionally, in the second loop 504, vehicle C's profile can indicate that it will complete the route with second loop 510 before vehicle D 512. Accordingly, vehicle C 510 can be selected and a ride scheduled for Rider A.

The automated ride-sharing service can use information (such as traffic speed, road conditions, known co-rider pickup and/or drop-off schedules, driver's historical average speeds, etc.) to predict a ride time. This ride time value can be used to select a ride for a user when the user indicates that time is ‘of the essence’.

The automated ride-sharing service can include functionalities for the gamification of the automated ride-sharing system. Users can “check in” at venues using a mobile website, text messaging and/or a device-specific application. The automated ride-sharing service can use information to offer users various specials, coupons and/or other incentives to check in. These can also be provided by third-party business. Some aspects of a rider's profile can be exposed to the third-party businesses. Users can also receive badges and other designations based on various check in factors.

In one embodiment, a driver can wear an OHMD such as Google Glass®. The OHMD can display various driver-related information such as a rider list, rider images, visually indicated riders to be picked up, augmented-reality maps of loops, driving directions, and/or other route indicators (e.g. based on current field of view, head orientation, location, etc.). The OHMD can also visually display upcoming stop locations, visually identify riders at said stop locations and/or provide rider information (e.g. name, destination, etc.). The OHMD can visually indicate rider preferences (e.g. music preferences, vehicle temperature preferences, rider interaction preferences, etc.). In some embodiments, an outward facing camera in the OHMD can implement facial recognition algorithms based on one or more images of riders already stored in the system. In this way, the system can automatically track riders. For example, facial recognition and/or other computer vision processes can be used to mark passengers as ‘picked up’ and/or ‘dropped off’. Additionally, multiple feeds from a combination of digital cameras, such as in-vehicle cameras other mobile device cameras (e.g. a driver's smart phone) and/or the driver's OHMD, can be accessed by the system to perform rider tracking.

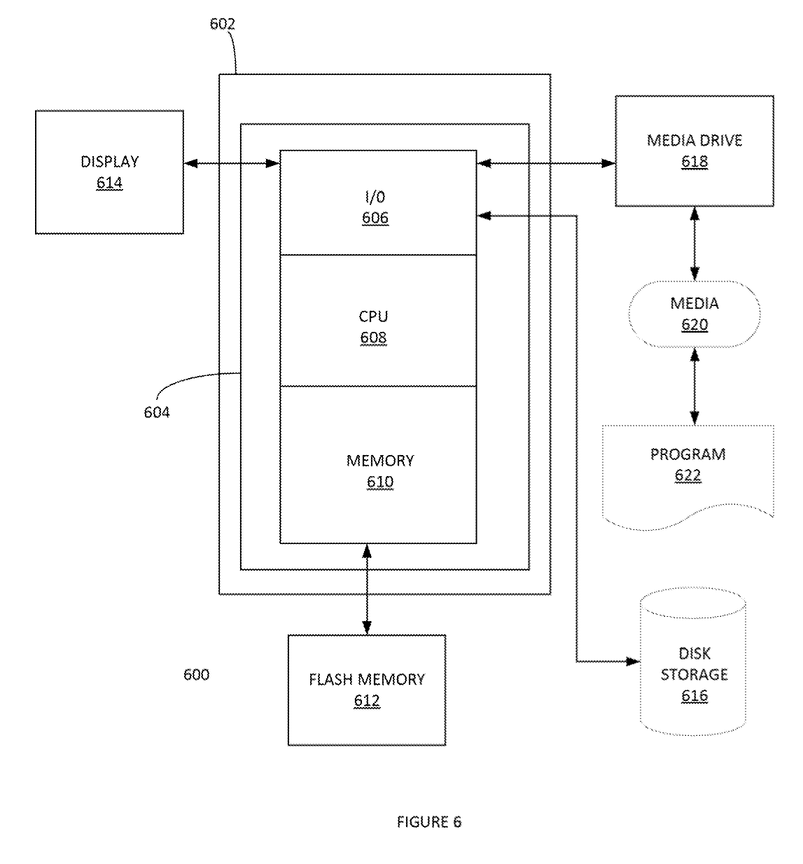

FIG. 6 depicts an exemplary computing system 600 that can be configured to perform any one of the processes provided herein. In this context, computing system 600 may include, for example, a processor, memory, storage, and I/O devices (e.g., monitor, keyboard, disk drive, Internet connection, etc.). However, computing system 600 may include circuitry or other specialized hardware for carrying out some or all aspects of the processes. In some operational settings, computing system 600 may be configured as a system that includes one or more units, each of which is configured to carry out some aspects of the processes either in software, hardware, or some combination thereof.

FIG. 6 depicts computing system 600 with a number of components that may be used to perform any of the processes described herein. The main system 602 includes a motherboard 604 having an I/O section 606, one or more central processing units (CPU) 608, and a memory section 610, which may have a flash memory card 612 related to it. The I/O section 606 can be connected to a display 614, a keyboard and/or other user input (not shown), a disk storage unit 616, and a media drive unit 618. The media drive unit 618 can read/write a computer-readable medium 620, which can contain programs 622 and/or data. Computing system 600 can include a web browser. Moreover, it is noted that computing system 600 can be configured to include additional systems in order to fulfill various functionalities. Computing system 600 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

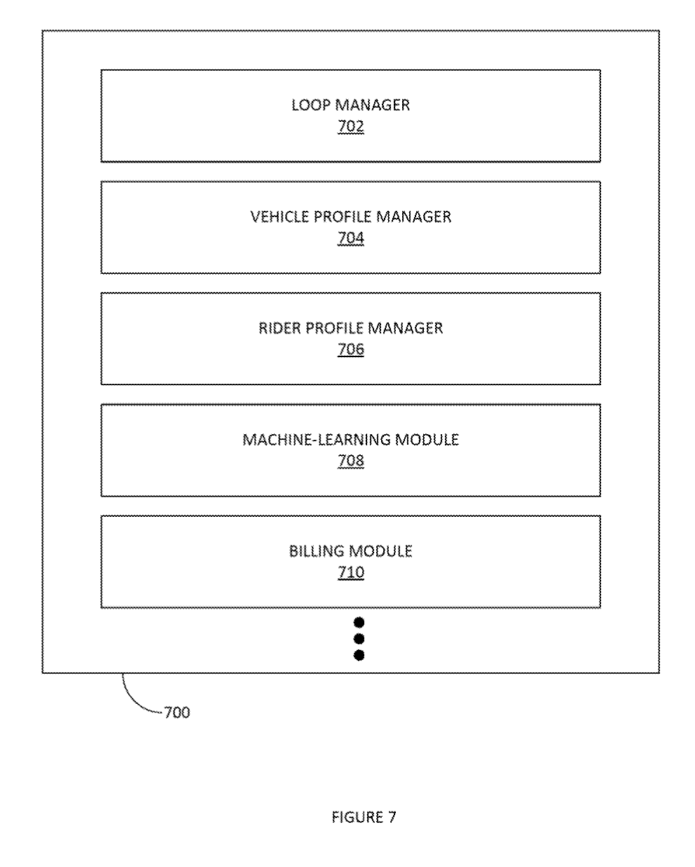

FIG. 7 depicts, in block diagram format, a computerized system 700 for implementing a multidimensional automated ride-sharing service, according to some embodiments. System 700 can implement any of the processes provided supra, including process 100, 200, 300, 400 and 500.

System 700 can include loop manager 702. Loop manager 702 can obtain various information used to generate loop routes. Loop manager 702 can schedule rider pick-ups and/or drop offs. Loop manager 702 can automatically optimize loop routes based on such factors as traffic congestion, road repairs, variations in rider pick-up and/or drop off schedules and/or locations, driver preferences, etc. Vehicle profile manager 704 can manage a profile of each active vehicle in the ride-sharing service. Vehicle profiles can include driver profile information, vehicle type and/or vehicle attributes. Vehicle profile manager 704 can information from driver inputs, riders inputs, vehicle telemetric systems in the vehicles, etc. Vehicle profile manager 704 can monitor vehicle location, speed and/or other attributes to ensure that driver's maintain loop routes and schedules.

Rider profile module 706 can manage a profile for each rider utilizing the ride-sharing service. Rider profiles can include any rider attribute used by the ride share system such as the rider profile attributes provide supra. Rider profile module 706 can further include various machine learning and/or optimization functionalities (such as those provided by machine learning module 708) to learn and/or predict implicit rider preferences. These learned and/or predicted rider preferences can also be utilized in the generation of rider profiles. In one example, a rider may consistently rate other talkative riders lower than non-talkative riders. The rider may not have provided an explicit preference for non-talkative co-riders. However, based on the pattern of rating non-talkative riders higher than talkative riders with otherwise similar profiles, rider profile module 706 can include the implicit preference in the rider's profile. Rider-profile module 706 can also learn implied rider attributes from a rider's online social network profile and/or behavior.

Machine learning module 708 can include various machine learning and/or optimization functionalities. System 700 can utilize machine learning module 708 to optimize loop routes, rider-to-rider matches, rider-to-vehicle matches, etc. Machine learning systems can include systems that can learn from data, rather than follow explicitly programmed instructions. Machine learning systems can implement various machine learning algorithms, such as, inter alia: supervised learning, unsupervised learning (e.g. artificial neural networks, hierarchal clustering, cluster analysis, association rule learning, etc.), semi-supervised learning, transductive inference, reinforcement learning, deep learning, etc. Machine learning module 708 can use machine learning algorithms to dynamically create a preference profile for a particular rider by detecting intersections of other rider attributes. Billing module 710 can manage the various billing services utilized by the ride-sharing service. System 700 can also include various other functionalities (not shown) such as web servers, email servers, text-messaging servers, online social networking servers, online dating service servers, etc. System 700 can be implemented in a cloud-computing environment.

In one example, a rider can utilize the ride-sharing service as a match making service. System 700 can provide a match-making web site. Other riders can view the rider's profile and indicate interest. If an interest is indicated by one or both riders, system 700 can match the two riders in the same vehicle in a ride share. If one rider has a reservation for a ride share service that is close in location and/or time to the other rider, system 700 can notify one or both riders. These riders can then have the option to modify their respective ride share reservations to be included in the other's ride share.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it can be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A system for implementing ride share services, comprising:
at least one computer processor disposed in a server; and
logic executable by the at least one computer processor, the logic configured to implement a method, the method comprising:
automatically determining a loop route for an automated ride-sharing service, wherein the loop route comprises a dynamic traveling route with one or more pickup/drop off points;
receiving a request from a rider to ride in a ride-sharing vehicle in the loop route;
generating a driver profile for a driver of the ride-share vehicle;
generating a co-rider profile for a co-rider in the ride-share vehicle;
receiving a ride-share vehicle restriction;
generating a vehicle ride profile based on the driver profile, the co-rider profile and the ride-share vehicle restriction;
generating a rider profile for the rider;
matching the rider profile with the vehicle ride profile;
scheduling a pickup for the rider by the ride-share vehicle; and
scheduling a drop off for the rider by the ride-share vehicle.

2. The system of claim 1, wherein the loop route is automatically modified based on a set of historical rider destination point for a current time period, a set of historical rider pick up points for a current time period and a set of traffic conditions for roads in the loop route.

3. The system of claim 1, wherein the ride-share vehicle restriction comprises a rider profession type.

4. The system of claim 3,
wherein the rider profile indicates that the rider is included in the rider profession type, and
wherein the the co-rider profile indicates that the co-rider is in the rider profession type.

5. The system of claim 4, wherein the loop route traverses a geographical area of a conurbation associated with the rider profession type.

6. The system of claim 5, wherein the rider profession type comprises an information technology professional.

7. The system of claim 6, wherein the rider profession type of a co-rider is verified by another rider of a same rider profession type.

8. The system of claim 1 further comprising:
determining a co-rider pickup and/or drop-off schedule on the loop route;
predicting a ride time for the rider utilizing the co-rider pickup and/or drop-off schedule; and
generating the vehicle ride profile based on the driver profile, the co-rider profile, the ride-share vehicle restriction, and the predicted ride time when the request from the rider indicates that time is of the essence.

9. The system of claim 1, wherein the rider profile comprises a set of rider preferences with respect to the ride-sharing vehicles, a driver attribute and a co-rider attribute.

10. A method of implementing a ride share service, comprising:
automatically determining a loop route for an automated ride-sharing service, wherein the loop route comprises a dynamic traveling route with one or more pickup/drop off points;
receiving a request from a rider to ride in a ride-sharing vehicle in the loop route;
generating a driver profile for a driver of the ride-share vehicle;
generating a co-rider profile for a co-rider in the ride-share vehicle;
receiving a ride-share vehicle restriction;
generating a vehicle ride profile based on the driver profile, the co-rider profile and the ride-share vehicle restriction;
generating a rider profile for the rider;
matching the rider profile with the vehicle ride profile;
scheduling a pickup for the rider by the ride-share vehicle; and
scheduling a drop off for the rider by the ride-share vehicle.

11. The method of claim 10 wherein the loop route is automatically modified based on a set of historical rider destination point for a current time period, a set of historical rider pick up points for a current time period and a set of traffic conditions for roads in the loop route.

12. The method of claim 10, wherein the ride-share vehicle restriction comprises a rider profession type.

13. The method of claim 12,
wherein the rider profile indicates that the rider is included in the rider profession type, and
wherein the the co-rider profile indicates that the co-rider is in the rider profession type.

14. The method of claim 13, wherein the loop route traverses a geographical area of a conurbation associated with the rider profession type.

15. The method of claim 14, wherein the rider profession type comprises an information technology professional.

16. The method of claim 15, wherein the rider profession type of a co-rider is verified by another rider of a same rider profession type.
